(19) United States
(12) Patent Application Publication
(10) Pub. No.: US 2007/0202429 A1
(43) Pub. Date: Aug. 30, 2007

(54) CARRIER PARTICLES COATED WITH A CONDUCTIVE COATING

(75) Inventors: Christopher M. Pattison, Rochester, NY (US); Deepak R. Maniar, Webster, NY (US); Thomas C. Dombroski, Rochester, NY (US); Brian Giannetto, Livonia, NY (US); Samir Kumar, Pittsford, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/276,437

(22) Filed: Feb. 28, 2006

(51) Int. Cl. G03G 9/113

(52) U.S. Cl. 430/111.35; 430/111.1

(57) ABSTRACT

The carrier core is coated whit a conductive coating that is more conductive than the core. This coating conductive particles coated with conductive polymer.

### TECHNICAL FIELD

The present disclosure relates to carrier compositions, and more specifically, carrier compositions coated with a conductive coating. These coated carrier compositions may be used in xerographic processes and devices.

### RELATED APPLICATION

U.S. Published Patent Application No. 2005/0064194 describes carrier comprised of a core and a polymer coating, wherein the coating contains a conductive polypyrrole or polyaniline contained in a carbon black matrix. In embodiments, the polymer coating contains polymethylmethacrylate and EEONOMER™.

The appropriate components and process aspects of the foregoing may be selected for the present disclosure in embodiments thereof, and the entire disclosure of the above-mentioned patent application is totally incorporated herein by reference.

### REFERENCES

U.S. Pat. No. 4,935,326 discloses a carrier and developer composition, and a process for the preparation of carrier particles with substantially stable conductivity parameters which comprises (1) providing carrier cores and a polymer mixture; (2) dry mixing the cores and the polymer mixture; (3) heating the carrier core particles and polymer mixture, whereby the polymer mixture melts and fuses to the carrier core particles; and (4) thereafter cooling the resulting coated carrier particles. These particulate carriers for electrophotographic toners are described to be comprised of core particles with a coating thereover comprised of a fused film of a mixture of first and second polymers which are not in close proximity in the triboelectric series, the mixture being selected from the group consisting of polyvinylidenefluoride and polyethylene; polymethyl methacrylate and copolyethylene vinyl acetate; copolyvinylidenefluoride tetrafluoroethylene and polyethylenes; copolyvinylidenefluoride tetrafluoroethylene and copolyethylene vinyl acetate; and polymethyl methacrylate and polyvinylidenefluoride.

There is illustrated in U.S. Pat. No. 6,042,981 carriers including a polymer coating wherein the polymer coating may contain a conductive component, such as carbon black, and which conductive component, may be dispersed in the polymer coating. The conductive component is incorporated into the polymer coating of the carrier core by combining the carrier core, polymer coating, and the conductive component in a mixing process such as cascade roll mixing, tumbling, milling, shaking, electrostatic powder cloud spraying, fluidized bed, electrostatic disc processing or by an electrostatic curtain. After the mixing process, heating is initiated to coat the carrier core with the polymer coating and conductive component.

U.S. Pat. No. 6,355,391 describes a micro-powder that can be used as a coating for carrier core particles. The micro-powder includes a sub-micron sized powder recovered from a synthetic latex emulsion of polymer and surfactant, and a conductive filler incorporated into the powder. The patent indicates that, in embodiments, the polymer is a methyl methacrylate polymer or copolymer. The conductive filler may be any suitable material exhibiting conductivity, e.g., metal oxides, metals, carbon black, etc. The patent also discloses incorporating the micro-powder onto the surface of carrier, followed by heating.

There is illustrated in U.S. Pat. No. 6,764,799 carrier comprised of a core and thereover a polymer coating, the polymer coating being generated by the emulsion polymerization of one or more monomers and a surfactant. This patent specifically indicates that the coated carriers are substantially free of or free of conductive components like conductive carbon blacks.

The appropriate components and process aspects of the foregoing may be selected for the present disclosure in embodiments thereof, and the entire disclosure of the above-mentioned patents is totally incorporated herein by reference.

### BACKGROUND

The electrostatographic process, and particularly the xerographic process, is known. This process involves the formation of an electrostatic latent image on a photoreceptor, followed by development of the image with a developer, and subsequent transfer of the image to a suitable substrate. In xerography, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. The radiation selectively dissipates the charge on the illuminated areas of the photoconductive insulating layer while leaving behind an electrostatic latent image on the non-illuminated areas. This electrostatic latent image may then be developed to form a visible image by depositing finely divided electroscopic marking particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Numerous different types of xerographic imaging processes are known wherein, for example, insulative developer particles or conductive developer particles are selected depending on the development systems used. Moreover, of importance with respect to the aforementioned developer compositions is the appropriate triboelectric charging values associated therewith, as it is these values that enable continued formation of developed images of high quality and excellent resolution. In two component developer compositions, carrier particles are used in charging the toner particles.

Carrier particles in part comprise a roughly spherical core, often referred to as the “carrier core,” which may be made from a variety of materials. The core is often coated with a resin. This resin may be made from a polymer or copolymer. The resin may have conductive material or charge enhancing additives incorporated into it to provide the carrier particles with more desirable and consistent triboelectric properties. The resin may be in the form of a powder, which may be used to coat the carrier particle. Often the powder or resin is referred to as the “carrier coating” or “coating.”

Known methods of incorporating conductive material into carrier coating include the use of electrostatic attraction, mechanical impaction, in situ polymerization, dry-blending, thermal fusion and others. These methods of incorporating conductive material into carrier coatings often result in only minimal amounts of conductive material being incorporated into the coating or produces conductive carrier coatings too large for effective and efficient use in some of the smaller carriers. Other conductive coating resins use dry-blending processes and other mixing to incorporate the carbon black or other conductive material into the polymer. However, in order to avoid transfer of carbon black from conductive polymers so obtained, the amount of carbon black that can be blended is severely limited, e.g., to 10% by weight or less. This in turn severely limits the conductivity achievable by the resultant conductive polymer.

In addition to the problems associated with loading conductive materials into coating resins, recent efforts to advance carrier particle science have focused on the attainment of coatings for carrier particles to improve development quality and provide particles that can be recycled and that do not adversely affect the imaging member in any substantial manner. Many of the present commercial coatings can deteriorate rapidly, especially when selected for a continuous xerographic process where the entire coating may separate from the carrier core in the form of chips or flakes causing failure upon impact or abrasive contact with machine parts and other carrier particles. These flakes or chips, which cannot generally be reclaimed from the developer mixture, have an adverse effect on the triboelectric charging characteristics of the carrier particles, thereby providing images with lower resolution in comparison to those compositions wherein the carrier coatings are retained on the surface of the core substrate.

Further, another problem encountered with some prior art carrier coatings resides in fluctuating triboelectric charging characteristics, particularly with changes in relative humidity. High relative humidity hinders image density in the xerographic process, may cause background deposits, leads to developer instability, and may result in an overall degeneration of print quality. In the science of xerography, the term “A Zone” is used to refer to hot and humid conditions, while the term “C Zone” is used to refer to cold and dry conditions. Triboelectric charges are usually lower in the “A Zone” than in the “C Zone.” It is desirable to have the measured triboelectric charges (_{tc}) for a particular carrier in the A Zone and the C Zone, when entered into a ratio of A zone_{tc}/C zone_{tc}, to be close to 1.0 in order to obtain good development in high humidity.

A carrier coating commonly used is #MP-116 PMMA available from Soken Chemical in Japan. This powder typically has a diameter of 0.4 to 0.5 micrometers and is a made from polymethyl methacrylate. However, it is required to use high amounts of #MP-116 PMMA to coat 30 to 150 micrometer carrier cores to achieve surface area coverage on the carrier of 85% to 95%. Use of such high amounts of carrier coating often results in lower carrier yields due to fused aggregates. Fused aggregates must be broken up or removed by screening. Crushing or breaking up of the aggregates may result in weak or “chipped off” areas on the carrier surface potentially causing poor coating quality. Screen separation may result in a lower yield as aggregates are removed from the final product.

Various coated carrier particles for use in electrostatographic developers are known in the art. Carrier particles for use in the development of electrostatic latent images are described in many patents including, for example U.S. Pat. No. 3,590,000. These carrier particles may comprise various cores with a coating thereover of fluoro-polymers and ter-polymers of styrene, methacrylate, and silane compounds.

There is a continuing need to be able to incorporate high amounts of conductive material into coating resins while providing for and maintaining desirable xerographic qualities such as high coating efficiency, proper performance, and stable charging characteristics.

### SUMMARY

The present disclosure discloses carrier comprising a core and a coating that is more conductive than the core. In embodiments, the core is conductive.

In embodiments, the coating comprises conductive particles coated with conductive polymer.

In embodiments, the core comprises a material other than steel. For example, in embodiments, the core comprises magnetite and/or ferrite.

In embodiments, the core has a density of no more than 6.5 g/cm³. In particular, the core can have a density of from about 0.5 g/cm³ to about 6 g/cm³, such as from about 1, 2, 3 or 4 g/cm³ to about 5.8 or 5.5 g/cm³.

### BRIEF DESCRIPTION OF THE DRAWINGS

Various exemplary embodiments of the disclosure will be described in detail, with reference to the following figures, wherein:

FIG. 1 depicts the conductive path of prior art coated carrier; and

FIG. 2 depicts the conductive path of coated carrier in which the coating is more conductive than the core.

### EMBODIMENTS

It was found that by loading enough conductive particles, particularly conductive particles coated with conductive polymer, into the core coating, carrier could be obtained in which the coating is more conductive than the conductive core. In embodiments in which the coating is more conductive than the core, it is possible to produce carrier that is more conductive that the core material. The reason for this is that the conductive path is through the coating material.

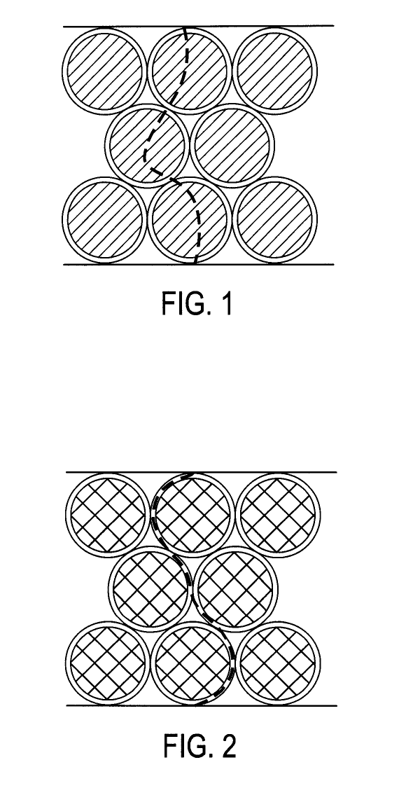

Past carriers have relied on the core material to provide the conductive path. See FIG. 1. Because the conductive path travels through the coating in order to reach the core, the carrier is often less conductive than the core. However, by forming carrier in which the conductive path is through the coating material, carrier that is more conductive than the core can be obtained. See FIG. 2.

In the past, to obtain high conductivity, irregular steel core has been used. The density of this material causes it to be more abusive to the developer housing than other core materials. However, by relying on the coating to provide the conductive path, one can substitute a less dense core such as magnetite or ferrite, with lower inherent conductivity, yet maintain or improve the carrier conductivity over the steel core.

In embodiments, the present disclosure is directed to carrier comprising a core and a coating, the coating comprising conductive particles coated with conductive polymer. In embodiments, the core is conductive. For example, the core may comprise metal. In particular embodiments, the core comprises at least one of magnetite or ferrite.

In embodiments, the core has a conductivity less than 1×10⁻⁸ (ohm-cm)⁻¹, such as from 0 to about 9×10⁻⁹ (ohm-cm)⁻¹.

In embodiments, the conductive particles that are in the coating of the carrier comprise carbon black. In embodiments, the conductive polymer that coats the conductive particles is at least one of polyaniline or polypyrrole. However, other conductive particles and/or conductive polymers may also be used.

In embodiments, the conductive polymer is formed by in situ polymerization of the conductive polymer in a matrix of the conductive particles.

In particular embodiments, the conductive particles coated with conductive polymer are the particles described in U.S. Pat. No. 6,132,645, which is herein incorporated by reference in its entirety. In embodiments, the coating composition is an electrically conductive polymeric composition as described in U.S. Pat. No. 5,498,372, which is herein incorporated by reference in its entirety. In particular embodiments, the conductive particles coated with conductive polymer are a product known as EEONOMER™, which can be obtained from Eeonyx Corporation. EEONOMER™ is an intrinsically conductive polymer (ICP) additive. It is understood that EEONOMER™ is prepared by in-situ polymerization and deposition of intrinsically conductive polymers, such as polyaniline or polypyrrole, into a carbon black or other matrix. The polymerization involves a catalyzed, oxidative polymerization of the monomer onto, in particular, carbon black. The conductivity of the ICP is, for example, from about 10 to about 50, and more specifically, from about 10 to about 40 Siemens/cm measured, for example, utilizing a pressed pellet per ASTM F84 and D257.

In embodiments, the particle size median diameter of the conductive particles coated with conductive polymer is, for example, equal to or less than about 100 nanometers, such as from about 25 to about 75 nanometers, and/or have a particle size distribution wherein 99 percent of the particles are of a diameter of below about 100 nanometers, that is for example about 1 percent of the particles are as large as 300 nanometers.

In embodiments, the coating on the carrier core comprises (i) conductive particles coated with conductive polymer, and (ii) a second polymer. The second polymer, which need not be conductive, is generally a polymer that will form a good coat on the carrier. However, the second polymer could be a conductive polymer and could, in fact, be the same polymer as the conductive polymer that is coated on the conductive particles.

In embodiments, the coating comprises from about 10% to about 30% by weight conductive particles coated with conductive polymer and from about 70% to about 90% by weight second polymer, such as from about 15% to about 25% by weight conductive particles coated with conductive polymer and from about 75% to about 85% by weight second polymer.

In embodiments, the second polymer is an acrylic polymer. In embodiments, the acrylic polymer is polymethylmethacrylate (PMMA) polymer or copolymer. Suitable comonomers that may be used to form a PMMA copolymer include, for example, monoalkyl or dialkyl amines such as dimethylaminoethyl methacrylate, diethylaminoethyl methacrylate, diisopropylaminoethyl methacrylate, acrylic or methacrylic acids, or fluoroalkyl or perfluorinated acrylic and methacrylic esters, such as, for example fluoro-ethyl methacrylate, specifically 2,2,2-trifluoro-ethyl methacrylate, or fluoro-ethylacrylate.

The coating may be adhered to the core by powder coating. In particular, conductive particles coated with conductive polymer can be mixed with polymer particles. The particle mixture can then be mixed with the carrier and heated to fuse the particles to the carrier core. However, the coating may be adhered to the core by other methods, such as solution coating, in situ polymerization and emulsion aggregation.

In embodiments, the polymethylmethacrylate polymer or copolymer is formed by polymerizing monomers in the presence of a surfactant, in particular, in the presence of sodium lauryl sulfate. Forming the polymethylmethacrylate polymer or copolymer in the presence of a surfactant, such as sodium lauryl sulfate, may produce a polymethylmethacrylate polymer or copolymer having an average particle size of less than 100 nm. Using polymer particles having such an average particle size may provide better coverage. In addition, polymer particles having an average particle size of less than 100 nm obtained without the use of a surfactant may also be used.

To form the polymer particles, the monomer or monomer mixture may be gradually mixed into an aqueous solution of surfactant such that only 5% to 30% of the total amount of monomer, is emulsified. Initiation of polymeric latex particles may be accomplished by rapid addition of a standard ammonium persulfate solution, followed by a metered addition of the remaining monomer supply. The metered rate may be from about 0.1 to about 5.0 grams per minute, such as about 1.5 grams per minute, for latex preparations of up to 350 grams. The mixing is generally continued after addition of the final amount of monomer. The temperature may be also maintained within a range of 60 to 70° C.

The mixing may be performed at a rate of, for example, about 50 to about 300 revolutions per minute for about 1 to 6 hours using any mechanical mixing apparatus known in the art. In embodiments, the dispersion is mixed at a rate of about 100-200 revolutions per minute for about 2 to 4 hours, with temperature between 65 to 67° C.

In embodiments, the surfactants are of the anionic type. Suitable surfactants include sodium lauryl sulfate (SLS), dodecylnapthalene sulfate, and others. In embodiments, no other surfactants of a different class or polarity are present.

The surfactant may be added in an amount of 0.2% to 5% by weight of the monomer polymerized. In an embodiment, the surfactant is SLS in the range of 0.4% to 0.8% by weight of the monomer to be polymerized. The initiator may be ammonium persulfate in a range of 0.2% to 1.0% by weight of the monomer. By procedures known to the art, surfactant concentration is used to regulate latex particle size, while initiator level is used to regulate the molecular weight of the polymer produced.

The recovery of the polymer particles from the emulsion suspension can be accomplished by processes known in the art. For example, the emulsion of polymer particles can first be filtered by any suitable material. In an embodiment, a cheese cloth is used. The polymer particles can then be washed, but in an embodiment, the polymer particles are not washed. At least in embodiments in which the polymer particles are not washed, some amount of the surfactant may be allowed to remain in association with the polymer particles. Allowing some amount of the surfactant to remain in association with the polymer particles may provide for better particle formation and better carrier coating characteristics. It is believed that the surfactants' interplay with the surface chemistry of the polymer particles provides for these improved results. Finally, the polymer particles are dried using, e.g., freeze drying, spray drying or vacuum techniques known in the art.

The polymer particles isolated from the process have an initial size of, for example, from about 0.01 micrometers to <1.0 micrometer. Due to physical aggregates, some of the polymer particles may initially be larger than 1.0 micrometer. During the mixing process with the conductive particles and/or the carrier cores, the physical aggregates of the polymer particles will be broken up into sub-micron polymer particles. In embodiments, the polymer particles obtained by the process herein have a size of, for example, from about 0.04 micrometers to about 0.250 micrometers, such as from about 0.08 micrometers to about 0.100 micrometers, that is, from 80 to 100 nm.

After the formation and recovery of the polymer particles, conductive particles coated with conductive polymer are incorporated with the polymer particles.

The coating of the present disclosure enables carriers to achieve a wide range of conductivity. Carriers using the coating of the present disclosure may exhibit conductivity of from about 10⁻⁵ to about 10⁻¹⁴ (ohm-cm)⁻¹. In embodiments, carriers using the coating of the present disclosure may exhibit conductivity of from about 10⁻⁵ to about 10⁻¹⁰ (ohm-cm)⁻¹.

The conductive particles coated with conductive polymer incorporated with the polymer particles in the process has a size of, for example, from about 0.012 micrometers to about 0.5 micrometers. In embodiments, these conductive particles have a size of, for example, from about 0.02 micrometers to about 0.05 micrometers.

The conductive particles coated with conductive polymer is incorporated with the polymer particles using techniques known in the art including the use of various types of mixing and/or electrostatic attraction, mechanical impaction, dry-blending, thermal fusion and others.

In embodiments, the weight of the coating is less than 2% by weight of the core. In embodiments, the weight of the coating is less than 1% by weight of the core. However, even with such a low coating amount, it was found that coverage of greater than about 80% could be obtained.

In addition to incorporating conductive particles into carrier coatings, it is often desirable to impart varying charge characteristics to the carrier particle by incorporating charge enhancing additives. If incorporated with the polymer particles, the charge enhancing additives may be incorporated in a premixing process before or after the incorporation of the conductive particles.

Typical charge enhancing additives include particulate amine resins, such as melamine, and certain fluoro polymer powders such as alkyl-amino acrylates and methacrylates, polyamides, and fluorinated polymers, such as polyvinylidine fluoride (PVF₂) and poly(tetrafluoroethylene), and fluoroalkyl methacrylates such as 2,2,2-trifluoroethyl methacrylate.

Other charge enhancing additives such as, for example, those illustrated in U.S. Pat. No. 5,928,830, incorporated by reference herein, including quaternary ammonium salts, and more specifically, distearyl dimethyl ammonium methyl sulfate (DDAMS), bis-1-(3,5-disubstituted-2-hydroxy phenyl)axo-3-(mono-substituted)-2-naphthalenolato(2-) chromate(1-), ammonium sodium and hydrogen (TRH), cetyl pyridinium chloride(CPC), FANAL PINK.RTM. D4830, and the like and others as specifically illustrated therein may also be utilized in the present disclosure.

The charge additives may be added in various effective amounts, such as from about 0.5% to about 20% by weight, based on the sum of the weights of all polymer, conductive particles, and charge additive components.

After the synthesis of the coating particles, the coating may be incorporated onto the surface of the carrier. Various effective suitable processes can be selected to apply a coating to the surface of the carrier particles. Examples of typical processes for this purpose include roll mixing, tumbling, milling, shaking, electrostatic powder cloud spraying, fluidized bed, electrostatic disc processing, and an electrostatic curtain. See, for example, U.S. Pat. No. 6,042,981, incorporated herein by reference.

Following incorporation of the powder onto the surface of the carrier, heating may be initiated to permit flow of the coating material over the surface of the carrier core. In an embodiment, the coating materials are fused to the carrier core in either a rotary kiln or by passing through a heated extruder apparatus.

In an embodiment, the conductive polymer particles of the present disclosure are used to coat carrier cores of any known type by any known method, which carriers are then incorporated with any known toner to form a developer for xerographic printing. Suitable carrier cores may be found in, for example, U.S. Pat. Nos. 4,937,166 and 4,935,326, incorporated herein by reference, and may include granular zircon, granular silicon, glass, steel, nickel, ferrites, magnetites, iron ferrites, silicon dioxide, and the like.

Carrier cores having a diameter in a range of, for example, about 5 micrometers to about 100 micrometers may be used. In embodiments, the carriers are, for example, about 20 or about 30 micrometers to about 80 or about 70 micrometers.

Typically, the coating covers, for example, about 60% to about 100% of the surface area of the carrier core using about 0.1% to about 3.0% coating weight. In embodiments, about 75% to about 98% of the surface area is covered with the coating using about 0.3% to about 2.0% coating weight. In embodiments, surface area coverage is about 85% to about 95% using about 1% coating weight.

Use of smaller-sized coating powders has proven more advantageous as a smaller amount by weight of the coating is needed to sufficiently coat a carrier core. Using less coating is cost effective and results in less coating separating from the carrier to interfere with the tribolelectric charging characteristics of the toner and/or developer.

In embodiments, the present disclosure is directed to the coated carrier described herein with toner on the surface of the carrier. In further embodiments, the present disclosure is directed to a xerographic device comprising such a developer. In the xerographic device, the developer described herein may be used with any suitable imaging member to form and develop electrostatic latent images.

### EXAMPLES

The following examples illustrate specific embodiments of the present disclosure. One skilled in the art would recognize that the appropriate reagents, component ratio/concentrations may be adjusted as necessary to achieve specific product characteristics. All parts and percentages are by weight unless otherwise indicated.

In the following examples, conductivity of the developer is a detoned developer conductivity. To measure the conductivity, toner is removed from the carrier and the conductivity is measured at 10 volts using the device described in U.S. Pat. No. 5,196,803.

### Example 1

EEONOMER™ 200F, which is composed of carbon black that has been surface treated with a polypyrrole, was mixed with Soken polymethylmethacrylate (PMMA) MP-116 particles at an EEONOMER™/PMMA ratio of 5% to 95% by weight. The resulting powder was powder coated onto a magnetite core with a coating weight of 1.7%. The conductivity of the resulting coated carrier was 4.33×10⁻¹⁴ (ohm-cm)⁻¹.

### Example 2

EEONOMER™ 200F was mixed with Soken PMMA MP-116 particles at an EEONOMER™/PMMA ratio of 20% to 80% by weight. The resulting powder was powder coated onto a magnetite core with a coating weight of 1.7%. The conductivity of the resulting coated carrier was 1.33×10⁻⁵ (ohm-cm)⁻¹.

### Example 3

EEONOMER™ 200F was mixed with Soken PMMA MP-116 particles at an EEONOMER™/PMMA ratio of 5% to 95% by weight. The resulting powder was powder coated onto a magnetite core with a coating weight of 0.6%. The conductivity of the resulting coated carrier was 2.93×10⁻¹¹ (ohm-cm)⁻¹.

### Example 4

EEONOMER™ 200F was mixed with Soken PMMA MP-116 particles at an EEONOMER™/PMMA ratio of 20% to 80% by weight. The resulting powder was powder coated onto a magnetite core with a coating weight of 0.6%. The conductivity of the resulting coated carrier was 9.86×10⁻⁶ (ohm-cm)⁻¹.

By comparison, uncoated steel has a conductivity of 2.16×10⁻⁸ (ohm-cm)⁻¹. In addition, uncoated magnetite has a conductivity of 8.25×10⁻⁹ (ohm-cm)⁻¹. Based on the fact that the 20:80 EEONOMER™/PMMA coated magnetite in Examples 2 and 4 have a conductivity higher than the core magnetite, it is clear that the conductive path of the carrier is through the coating.

It will be appreciated that various of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. Carrier comprising a core and a coating over the core, said coating being more conductive than the core, wherein said core does not comprise steel and said coating comprises conductive particles coated with conductive polymer.

2. Carrier according to claim 1, wherein said conductive particles comprise carbon black.

3. Carrier according to claim 1, wherein said conductive polymer is at least one of polyaniline or polypyrrole.

4. Carrier according to claim 1, wherein said conductive polymer is formed by in situ polymerization of the conductive polymer in a matrix of the conductive particles.

5. Carrier according to claim 1, wherein the coating over the core comprises an acrylic polymer.

6. Carrier according to claim 5, wherein the coating over the core comprises from about 10 to about 30 percent by weight conductive particles coated with a conductive polymer and from about 70 to about 90 percent by weight acrylic polymer.

7. Carrier according to claim 5, wherein said acrylic polymer is polymethyl methacrylate polymer or copolymer.

8. Carrier according to claim 1, wherein said core is conductive.

9. Carrier according to claim 1, wherein said core comprises at least one of magnetite or ferrite.

10. A developer comprising toner and carrier according to claim 1.

11. A xerographic device comprising an image forming member and a housing containing a developer according to claim 10.

12. Carrier comprising a core and a coating over the core, said coating being more conductive than the core, wherein said core has a density of no more than 6.5 g/cm³ and said coating comprises conductive particles coated with conductive polymer.

13. Carrier according to claim 12, wherein said core has a density of from about 0.5 g/cm³ to about 6 g/cm³.

14. Carrier according to claim 12, wherein said conductive particles comprise carbon black.

15. Carrier according to claim 12, wherein said conductive polymer is at lease one of polyaniline or polypyrrole.

16. Carrier according to claim 12, wherein said conductive polymer is formed by in situ polymerization of the conductive polymer in a matrix of the conductive particles.

17. Carrier according to claim 12, wherein the coating over the core comprises an acrylic polymer.

18. Carrier according to claim 12, wherein said core comprises at least one of magnetite or ferrite.

19. A developer comprising toner and carrier according to claim 12.

20. A xerographic device comprising an image forming member and a housing containing a developer according to claim 19.
